(19) United States
(12) Patent Application Publication
(10) Pub. No.: US 2008/0054860 A1
(43) Pub. Date: Mar. 6, 2008

(54) Hybrid linear switching voltage regulator

(75) Inventor: Richard Barry Angell, Nevada City, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: 2Wire, Inc.

(21) Appl. No.: 11/515,066

(22) Filed: Sep. 1, 2006

(51) Int. Cl. G05F 1/10

(52) U.S. Cl. 323/234

(57) ABSTRACT

A method, apparatus, and system are described in which a hybrid of two standard types of voltage regulators is formed. The hybrid voltage regulator may share a switching waveform with a switching waveform generator already in use on the circuit board, which may be a switching voltage regulator. This switching waveform acts as a control waveform for the hybrid voltage regulator, thus eliminating the need for another controller. The hybrid voltage regulator combines the functionality of a linear voltage regulator and a switching voltage regulator into one circuit. The shared switching waveform controls during operation as a switching voltage regulator. A second control waveform is generated by a control amplifier, which compares the regulated output voltage to a reference voltage. The second control waveform controls during operation as a linear voltage regulator.

### FIELD OF THE INVENTION

Aspects of embodiments of the invention relate to voltage regulation.

### BACKGROUND OF THE INVENTION

A voltage regulator provides a constant output voltage and contains circuitry that continuously tries to maintain the output voltage at the design value regardless of changes in load current or supply voltage. There are many ways to create a regulated voltage supply from a higher voltage power supply. Two of the most widely employed methods are the linear series regulator and the switching buck regulator. The linear series regulator has the advantage of a simple structure. Its disadvantage is often high waste power with low efficiency. The buck regulator has the advantage of high efficiency, but has the disadvantage of a complex structure, thus making it more expensive.

The linear regulator is best suited for low power applications and applications where the target output voltage is close to the available input voltage. The buck regulator is best suited for higher power applications, and applications in which the target output voltage is considerably different from the available input voltage. An example of this would be when the input voltage may vary over a wide range.

It is desirable for some applications to provide a voltage regulator with efficiency and cost somewhere in between the two standard methods. Some designs attempt to solve this problem by adding a second unregulated output to a standard switching converter. This has a number of disadvantages. It may increase the switching current in the first output inductor, requiring larger out capacitors. Load regulation is quite poor, so a linear regulator may be required after the unregulated output.

### BRIEF DESCRIPTION OF THE DRAWINGS

The drawings refer to embodiments of the invention in which:

FIG. 1 illustrates a schematic circuit diagram of an embodiment of controlling a first switching voltage regulator by employing a switching waveform from a second switching voltage regulator;

FIG. 2 illustrates a schematic circuit diagram of an embodiment of the two voltage regulators where they share a common input supply voltage;

FIG. 3 illustrates a schematic circuit diagram of an embodiment of the two voltage regulators where the input supply voltage of the first voltage regulator is derived from the output of the second voltage regulator;

FIG. 4 illustrates a schematic circuit diagram of an embodiment of the hybrid voltage regulator where the functionality of a linear voltage regulator is integrated into a switching voltage regulator;

FIG. 5 illustrates a schematic circuit diagram of an embodiment of the hybrid voltage regulator for use at higher frequencies;

FIG. 6 illustrates a schematic circuit diagram of an embodiment of the second switching voltage regulator;

FIG. 7 illustrates a schematic circuit diagram of an embodiment of the hybrid voltage regulator; and

FIG. 8 illustrates a block diagram of an embodiment of a discrete multiple tone system employing one or more voltage regulators.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific data signals, named components, connections, etc., in order to provide a thorough understanding of the embodiments of the invention. It will be apparent, however, to one of ordinary skill in the art that the embodiments of the invention may be practiced without these specific details. However, the specific numeric references should not be interpreted as a literal sequential order but rather interpreted that the first voltage regulator is different than a second voltage regulator. Thus, the specific details set forth are merely exemplary. The specific details may be varied from and still be contemplated to be within the spirit and scope of the claims.

In general, various methods and apparatuses are described for a hybrid linear switching voltage regulator. The invention comprises a hybrid of two standard types of voltage regulators. The hybrid voltage regulator may share a switching waveform with a switching waveform generator already in use on the circuit board, which may be a switching voltage regulator. This switching waveform acts as a control waveform for the hybrid voltage regulator, thus eliminating the need for another controller. The hybrid voltage regulator combines the functionality of a linear voltage regulator and a switching voltage regulator into one circuit. The shared switching waveform causes the pass transistor to turn fully off during a portion of the switching cycle. A second control waveform is generated by a control amplifier, which compares the regulated output voltage to a reference voltage. The second control waveform controls during operation as a linear voltage regulator. An embodiment involves sending a control switching waveform to a control terminal of a first switch of a first switching voltage regulator. The control switching waveform may be derived from an output signal of a second switch of a second switching voltage regulator. The embodiment also involves controlling the conduction of the first switch to provide a regulated output voltage that stays within preset high and low regulated voltage level tolerances over a range of no load current to a maximum design load current based on the control switching waveform supplied to the control terminal of the first switch.

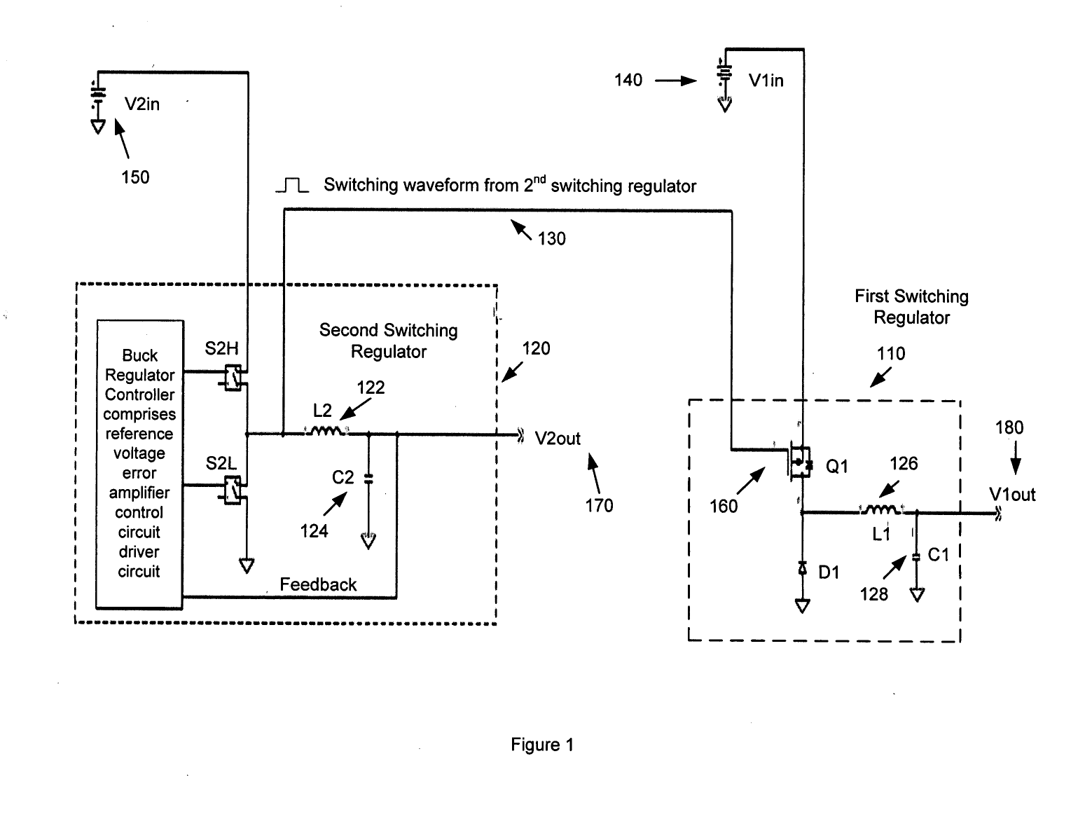

FIG. 1 illustrates a schematic diagram of an embodiment of controlling a first switching voltage regulator by employing a switching waveform from a second switching voltage regulator. The circuit may include components such as a first switching voltage regulator 110, a first inductor 126, a first capacitor 128, a first switch such as a transistor (Q1) 160, a buck voltage regulator 120, a second inductor 122, and a second capacitor 124.

The buck voltage regulator 120 sends a control switching waveform 130 to a control terminal of the first switch 160 of the first switching voltage regulator 110. The control switching waveform 130 is derived from an output of the second set of switches of the buck voltage regulator 120. The control switching waveform 130 supplied to the control terminal of the first switch 160, such as a gate terminal, controls a conduction of the first switch to provide a regulated output voltage that stays within preset high and low regulated voltage level tolerances over a range of no load current to a maximum design load current.

In an embodiment, the first voltage regulator 110 borrows the switching control waveform 130 of a second switching regulator 120 to control a switching transistor 160 for the first voltage regulator 110. This switching transistor 160 may be connected to a discrete supply voltage source 140. The switching waveform 130 from the second switching voltage regulator 120 has duty cycle D and is used to control the first voltage regulator's switching transistor 160. Thus, the duty cycle of the second switching voltage regulator 120 is used to control the duty cycle of the first voltage regulator's switching transistor 160. The duty cycle of the first voltage regulator 110 may be equal to one minus the duty cycle of the second switching voltage regulator 120.

For illustration we use an example transistor of a P-channel MOSFET. However, other types of switches could be used as well. This transistor 160 is turned on by a relatively negative signal at its source, so the duty cycle of this first switching regulator 110 is D′. In an embodiment, D′ is defined as (1-D). Note that it is not necessary to always use a P-channel MOSFET for the switch Q1 160. If the separate supply voltage source for the second switching regulator V2in 150 is considerably greater than V1in 140, then sufficient drive voltage would be available to control an N-channel MOSFET. Alternatively, a boost circuit could be employed to derive such voltage. In this case the equations below would be modified to reflect the new duty cycle.

If V2in 150 represents the supply voltage to the second switching regulator 120, V2out 170 represents the output voltage of the second switching regulator 120, D represents the duty cycle of the second switching regulator 120 and D′=(1−D), the following then applies to the ideal standard switching buck regulator: D=V2out 170/V2in 150. The output voltage 180 of this first regulator 110 will then be found from: V1Out 180=V1in 140*D′. For example, if V1in 140 is 5 Vdc and the regulated output voltage at V1out 180 is 1.2 Vdc. The control waveform from the second switching voltage regulator 120 will try to turn on switch Q1 160 approximately 24% of the time every duty cycle. (i.e. 1.2/5=24%).

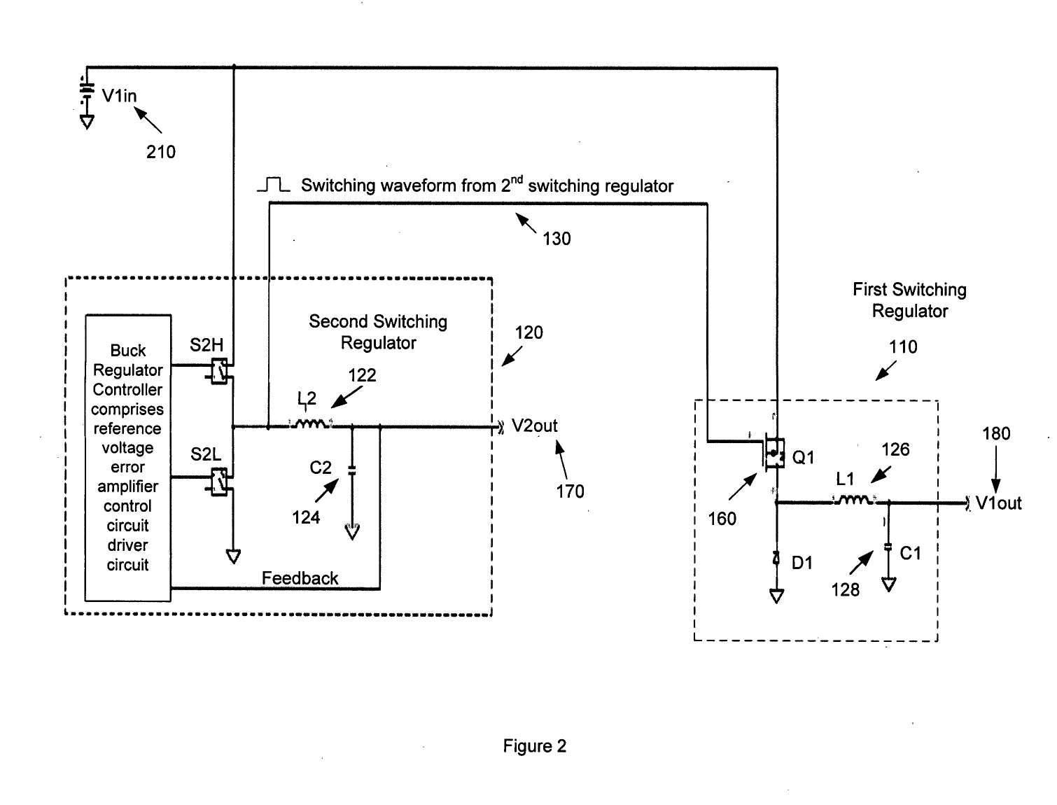

FIG. 2 illustrates a schematic diagram of an embodiment of the two switching voltage regulators where they share a common input supply voltage. The circuit may include a first switching voltage regulator 110, a second switching voltage regulator 120, and a shared power supply 210. The supply voltage terminal of the second switching voltage regulator 120 and the supply voltage terminal of the first switching voltage regulator 110 are connected to the common supply voltage 210 (V1in). In this case V1in=V2in, so V1out 180=V1in 210*(D′)=V1in 210*(1−V2out 170/V1in 210)=V1in 210−V2Out 170. This result shows that the first voltage regulator 110 has no or limited line regulation, which may be a disadvantage depending on application. However, the first regulator 110 has excellent load regulation and ideal output voltage 180 is independent of load current.

For example, let V1in 210=5V, V2out 170=1.15V. Then D=0.23. In practice this duty cycle may be slightly higher due to non-ideal losses in the components employed. Continuing with the example, D′=0.77. The hybrid regulator 110 will then have an ideal output voltage of V1in 210*D′=3.85V. This may be reduced by non-ideal losses in the components employed.

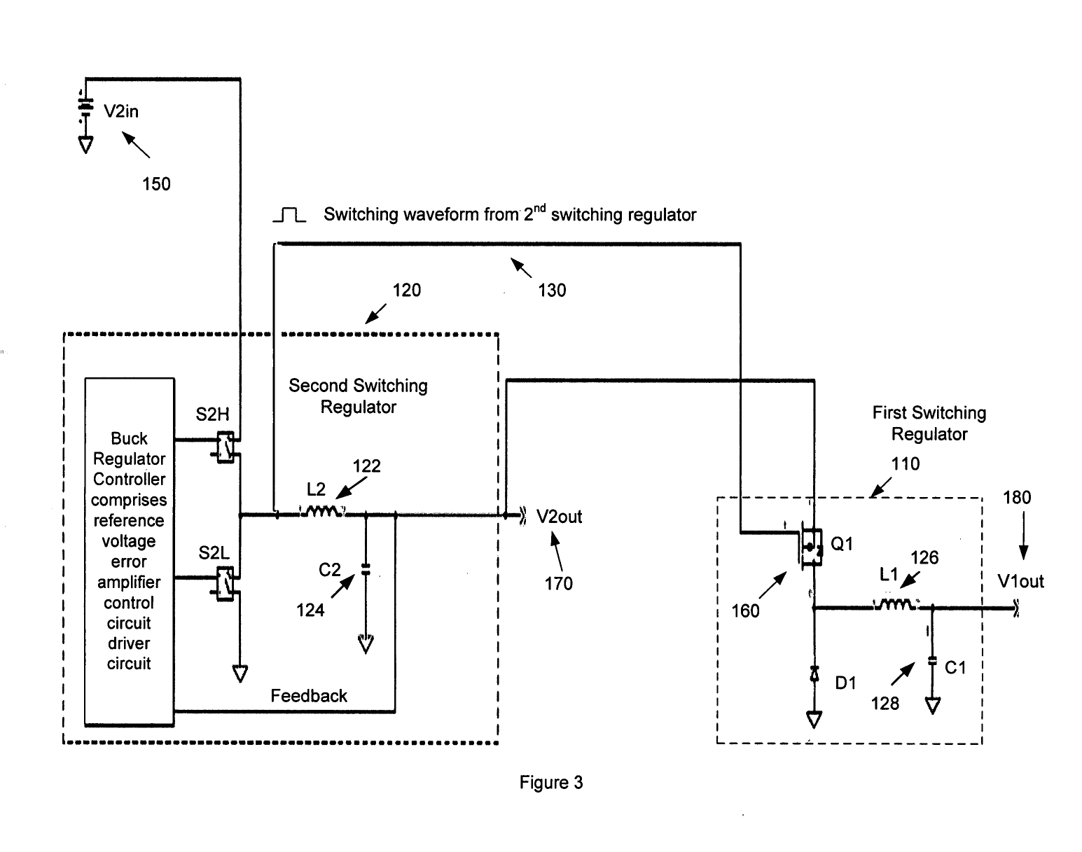

FIG. 3 illustrates a schematic diagram of an embodiment of another possible power connection. In this embodiment, the hybrid voltage regulator 110 derives its supply power from the output 170 of the first switching regulator 120. Thus, the regulated voltage output terminal 170 of the second switching voltage regulator 120 is connected to the supply voltage terminal of the first switching voltage regulator 110. In this embodiment, V1out 180=V1in*(D′)=V2Out 170*(1−V2Out 170/V2in 150)=V2Out 170−(V2Out 170²)/V2in 150. The second switching regulator 120 tightly regulates V1Out 180. The line regulation in this configuration is sensitive to the input voltage V2in 150 according to the expression above. Depending on the choice of voltages, this line regulation could be acceptable.

In another embodiment, there may be an input voltage 150 of 5V, and a second regulated output voltage 170 of 3.3V. In this case the output of the first voltage regulator 110, as found above, would be 1.12V. This could be used as an IC core voltage power supply. The sensitivity to input voltage variation would be 42 mV for 100 mV of input voltage variation. Thus, there is some inherent line regulation in this connection.

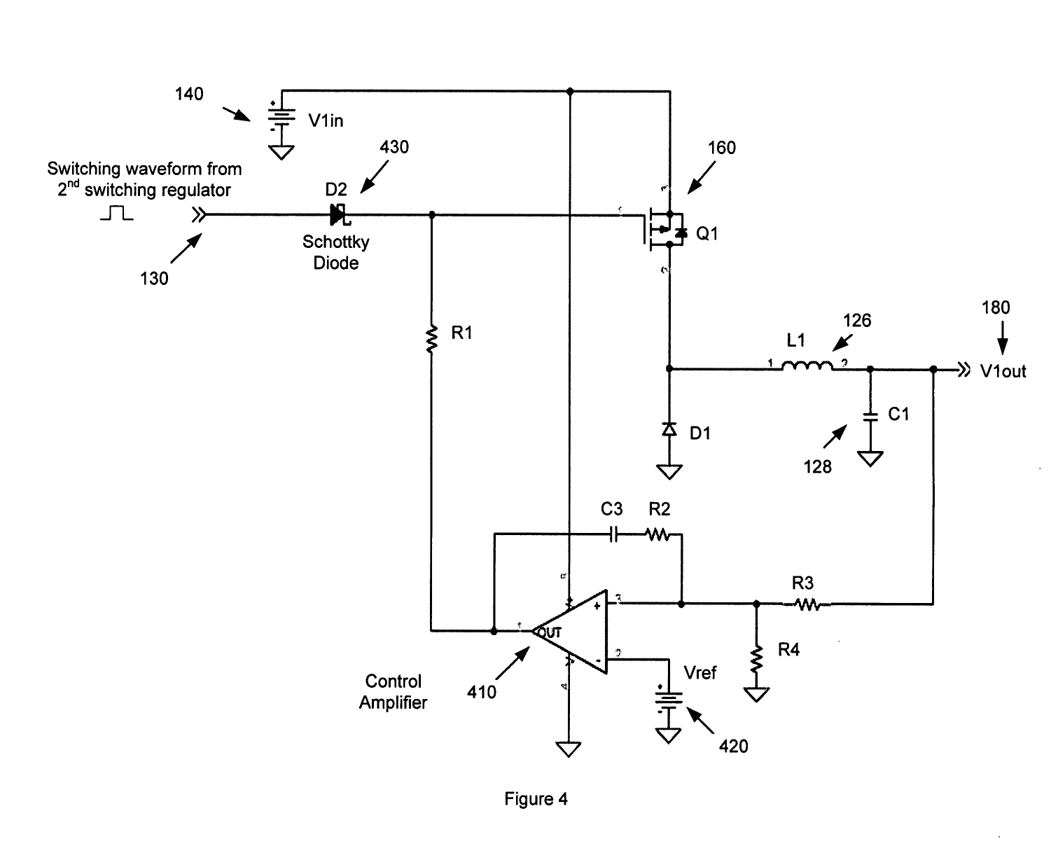

FIG. 4 illustrates a schematic diagram of an embodiment of the hybrid voltage regulator 110 where the functionality of a linear voltage regulator is integrated into a switching voltage regulator. A standard series regulator comprises 3 fundamental elements: a reference voltage, a control amplifier, and a series pass transistor. In the invention, the switching transistor 160 is employed as both a series pass transistor and a switching voltage regulator. The switching transistor 160 receives a first control switching waveform at its gate terminal while the switching transistor 160 operates as the switching voltage regulator. The switching transistor 160 receives a second control waveform at the gate terminal when the switching transistor 160 operates as the linear voltage regulator. Thus, the switching transistor 160, such as a field effect transistor, operates as both a switching voltage regulator and a linear voltage regulator based on receiving a first control signal on its control terminal when operated as a switching voltage regulator and a second control signal on its control terminal when operated as a linear voltage regulator.

The reference voltage may be derived in the standard fashion, from a bandgap reference, or it may be derived from the second switching voltage regulator 120. For simplicity in the drawings, an independent voltage reference, Vref 420 is shown. In practice, it may be less expensive to derive the reference voltage 420 from the second switching regulator 120. The regulated output voltage 180 of the first voltage regulator 110 may be compared to the reference voltage 420 so that a control amplifier can provide a feedback signal to control an amount of conduction of the switching transistor 160 to provide a regulated output voltage that stays within the preset high and low regulated voltage level tolerances.

The control amplifier 410 may be a standard op-amp. In the invention, the control amplifier 410 adjusts the voltage of the switching control waveform 130. Thus the switching transistor 160 is always off when the switching waveform 130 is positive. However, when the switching waveform 130 is negative, the amplifier 410 controls the magnitude of the negative gate excursion. For a given input voltage, duty cycle, and constant load, the output of the control amplifier 410 would attain a constant level suitable for maintaining the desired output voltage V1Out 180.

When the switching waveform is positive, the Schottky diode 430 is on and the FET 160 is off. When the switching waveform 130 is negative, the diode 430 is off, blocking the control signal 130. In this case, the control amplifier 410 controls the gate and the switch 160 is only partially on while acting as a linear regulator. There is a voltage drop across Q1 160 providing additional voltage regulation.

The control amplifier 410 compares the first regulated voltage level 180 of the first voltage regulator to a reference voltage to provide the second control signal to control an amount of conduction of the first switching transistor 160. This will provide a regulated output voltage that stays within preset high and low regulated voltage level tolerances. The second control signal from the operational amplifier 410 supplies feedback to control the regulated voltage output 180. Thus, a gate terminal drive voltage of the first transistor switch 160 is augmented through a use of the first diode D1 and the control amplifier 410 so that the first transistor switch 160 operates in a linear state of conduction to provide a regulated output voltage that stays within preset high and low regulated voltage level tolerances. The control amplifier 410 controls the conduction of the first switching transistor 160 when the first control signal 130 is blocked via reverse biasing the input Schottky diode 430.

Also, a first diode D1 and the gain of the control amplifier are configured to increase the current flowing to the control terminal of the first switch Q1 to change states of the first switch Q1 in order to achieve a rise time of the second control signal to be less than five percent of a period of the second control signal. The rapid rise time provides a clean edge for switching the first transistor switch 160 on and off.

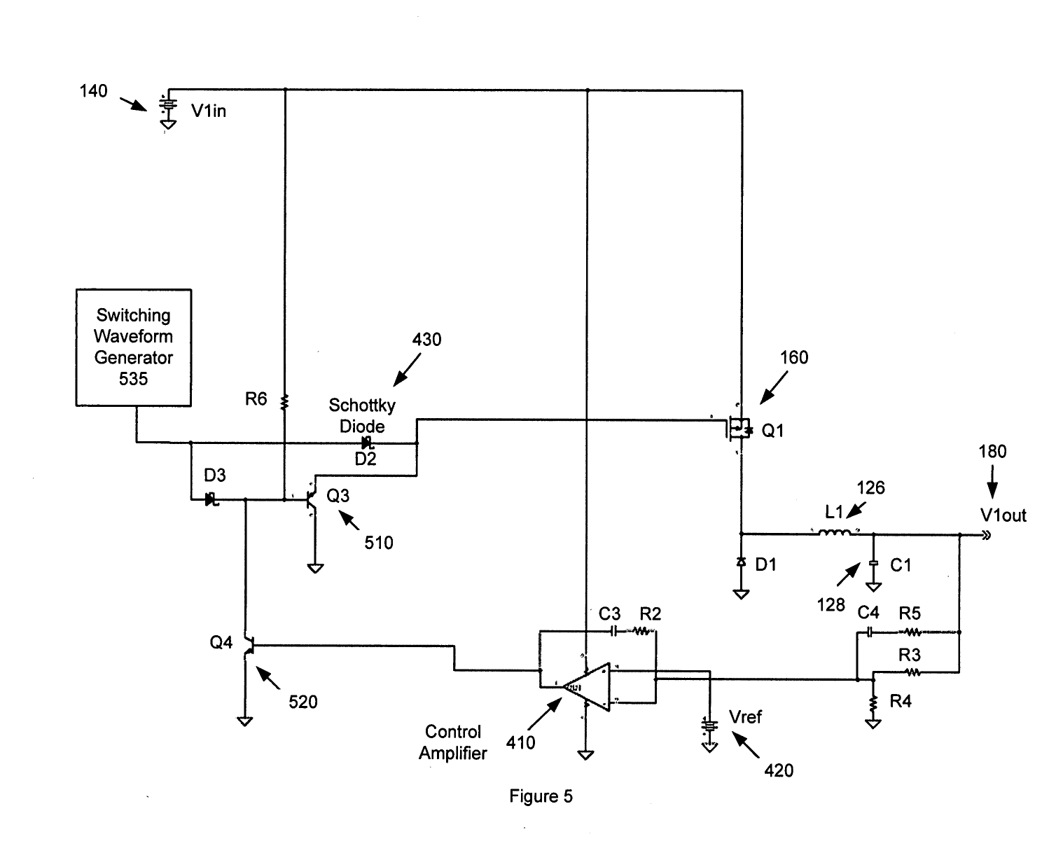

FIG. 5 illustrates a schematic diagram of an embodiment of the hybrid voltage regulator 110 for use at higher frequencies. At higher frequencies, more gate drive would be required, and this figure illustrates a method for deriving this high-speed, high-current control waveform. Additional diodes and transistors 510, 520 are configured to increase the current flowing to the control terminal of the switch 160 in the first voltage regulator 110 to change states of the switch 160 in order to achieve a rise time of the second control signal that is less than five percent of the period of the second control signal. At higher frequencies, more current means faster switching time, which allows for a smaller inductor and capacitor to support the designed load of the voltage regulator.

As discussed, a switching waveform generator 535 such as another buck voltage regulator or any other switching source with a fast rise and fall time on its output wave form, generates a switching waveform that is connected to the control terminal of the switch 160 in a voltage regulator to control the conduction of the first switch to provide a regulated output voltage that stays within the preset high and low regulated voltage level tolerances over a range of no load current to a maximum design load current.

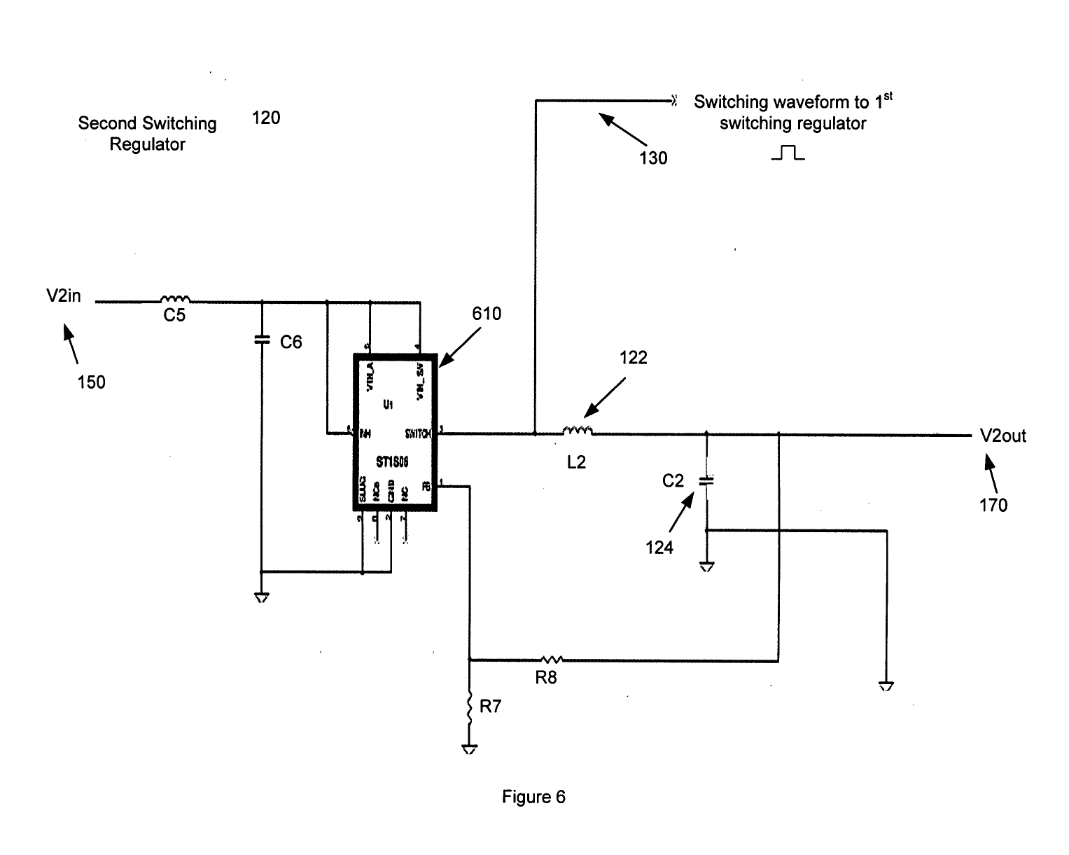

FIG. 6 illustrates a schematic diagram of an embodiment of the second switching voltage regulator 120. As a switching regulator, the regulator 120 uses a transistor 610 as a switch that alternately connects and disconnects the input voltage 150 to an inductor 122. When the switch 610 turns on, the input voltage 150 is connected to the inductor 122. The difference between the input and output voltages is then forced across the inductor 122, causing current through the inductor 122 to increase. During the on time, the inductor current flows into both the load and the output capacitor 124 causing the capacitor 124 to charge during this time.

When the switch 610 is turned off, the input voltage 150 applied to the inductor 122 is removed. However, since the current in an inductor cannot change instantly, the voltage across the inductor 122 will adjust to hold the current constant. The input end of the inductor 122 is forced negative in voltage by the decreasing current, eventually reaching the point where the diode is turned on. The inductor current then flows through the load and back through the diode. The capacitor 124 discharges into the load during the off time, contributing to the total current being supplied to the load, making the total load current during the switch off time the sum of the inductor and capacitor current.

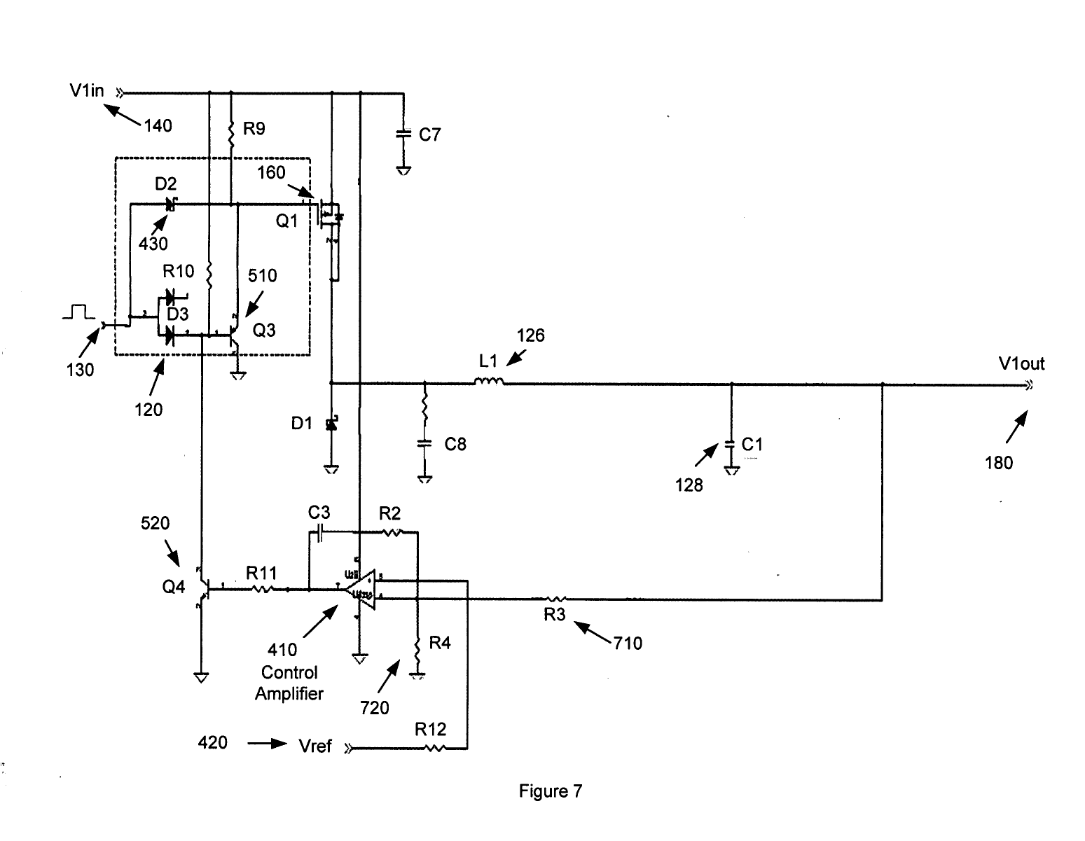

FIG. 7 illustrates a schematic diagram of an embodiment of the hybrid voltage regulator 110. When operating as a linear regulator, the switch 160 is partially on. The control amplifier 410 controls the current flowing out the emitter of the pass transistor 160. The feedback loop that controls the output voltage 170 is obtained by using R3 710 and R4 720 to sense the output voltage 170, and applying this sensed voltage to the inverting input of the control amplifier 410. The non-inverting input is tied to a reference voltage 420, which means the error amplifier will constantly adjust its output voltage (and the current through the switch) to force the voltages at its inputs to be equal. The feedback loop action continuously holds the regulated output at a fixed value, which is a multiple of the reference voltage regardless of changes in load current. Q3 510 and Q4 520 increase current flowing to Q1 160 to allow a rise time that is less than five percent of the period of the second control signal, which allows for a smaller inductor and capacitor to support the designed load of the voltage regulator. For example, the rise time in the square wave waveform should be ten nanoseconds or less for a one millisecond duty cycle.

Accordingly, as a switching voltage regulator, the regulated output voltage 180 tends to approximate a target output value such as 2.2 Vdc. As a linear voltage regulator (i.e. series pass regulator), the regulated output voltage 180 tends to hold constantly at the regulated output voltage such as 2.2 Vdc and vary slightly when significant load changes occur.

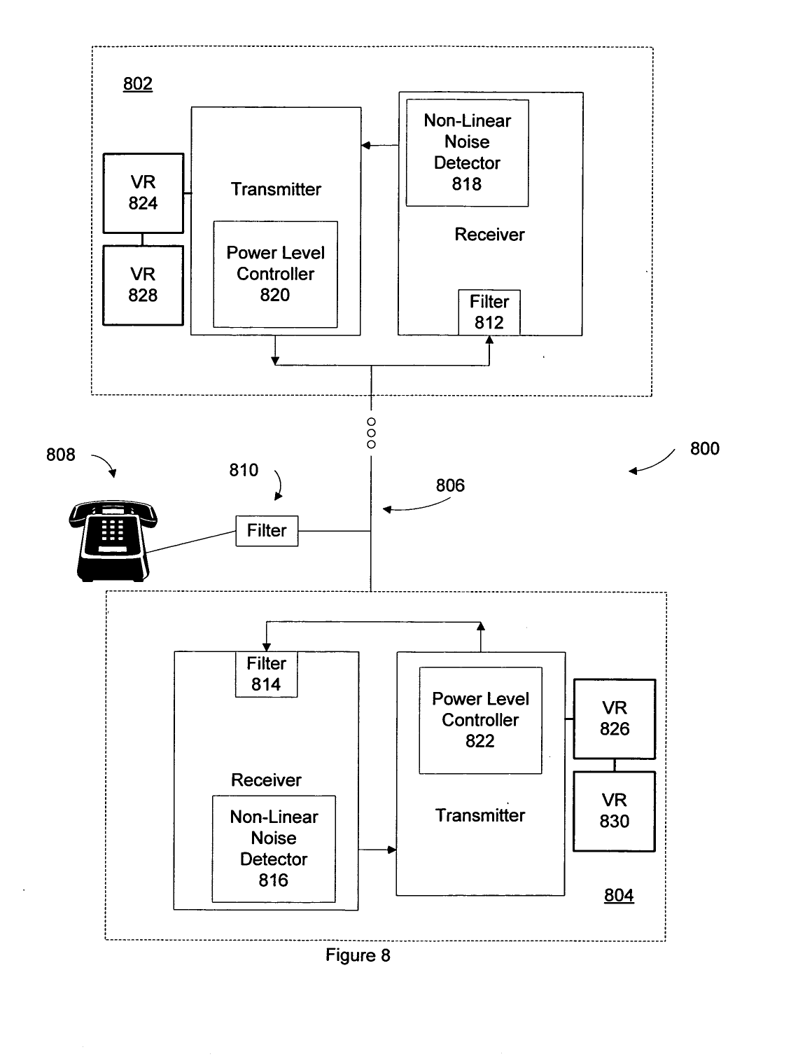

FIG. 8 illustrates a block diagram of an embodiment of a discrete multiple tone system that detects for impulse noise present on the transmission medium. The system has a transmitter that separates upstream communication signals and down stream communication signals into two or more distinct frequency bands and one or more voltage regulators to supply voltage to components within the transmitter-receiver. The discrete multiple tone system 800, such as a Digital Subscriber Line (DSL) based network, may have two or more transmitter-receiver devices 802, 804, such as a DSL modem in a set top box. The first transmitter-receiver device 802, such as a Discrete Multi-Tone transmitter, transmits and receives communication signals from the second transmitter-receiver device 804 over a transmission medium 806, such as a telephone line. Other devices such as telephones 808 may also connect to this transmission medium 806. An isolating filter 810 generally exists between the telephone 808 and the transmission medium 806. A training period occurs when initially establishing communications between the first transmitter-receiver device 802 and a second transmitter-receiver device 804. The various circuits in the DSL modem may use one or more of the embodiments of the voltage regulators described above.

The discrete multiple tone system 800 may include a central office, multiple distribution points, and multiple end users. The central office may contain the first transmitter-receiver device 802 that communicates with the second transmitter-receiver device 804 at an end user's location.

The transmitter-receiver device may operate in the presence of severe impulse noise with minimal loss of data rate as compared to other known schemes for managing impulse noise.

Each transmitter portion of the transmitter-receiver device 802, 804 may transmit data over a number of mutually independent sub-channels i.e. tones. Each sub-channel carries only a certain portion of data through QAM of the sub-carrier. The number of information bits loaded on each tone and the size of corresponding QAM constellation may potentially vary from one tone to another and depend generally on the relative power of signal and noise at the receiver. When the characteristics of signal and noise are known for all tones, a bit-loading algorithm can determine the optimal distribution of data bits and signal power amongst sub-channels. Thus, the transmitter portion of the transmitter-receiver device 802, 804 modulates each sub-carrier with a data point in a QAM constellation.

Each transmitter-receiver device also includes a receiver portion that contains a noise detector 816, 818. Each noise detector 816, 818 may contain software and/or logic programmed to detect for the presence of impulse noise present in the system. Each noise detector 816, 818 may detect an error difference between an amplitude of each transmitted data point in the QAM constellation and an expected amplitude for each data point in the QAM constellation. Each noise detector 816, 818 may detect for the presence of impulse noise based on the error difference detected between the received data point and expected data point. Impulse noise generally has a short period and large magnitude, i.e. spikes, compared to the background noise. The error difference for each transmitted data point may be known as an error sample.

The first voltage regulator 824, 826 has a first transistor that operates as both a switching voltage regulator and a linear voltage regulator. The first voltage regulator 824, 826 receives a first control switching waveform on its control terminal from an output of a second switch in a second switching voltage regulator 828, 830.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

What is claimed is:

1. A method, comprising:
sending a control switching waveform to a control terminal of a first switch of a first switching voltage regulator, wherein the control switching waveform is derived from an output signal of a second switch of a second switching voltage regulator; and
controlling a conduction of the first switch to provide a regulated output voltage that stays within preset high and low regulated voltage level tolerances over a range of no load current to a maximum design load current based on the control switching waveform supplied to the control terminal of the first switch.

2. The method of claim 1, further comprising:
using a second duty cycle of the second switching voltage regulator to control a first duty cycle of the first switching voltage regulator.

3. The method of claim 2, wherein the first duty cycle of the first voltage regulator is equal to one minus the second duty cycle of the second voltage regulator.

4. The method of claim 1, further comprising:
operating the first switch of the first voltage regulator as a series pass transistor during a portion of the operation of the first switch.

5. A method, comprising:
operating a field effect transistor, that is a first switch of a first voltage regulator, as both a switching voltage regulator and a linear voltage regulator; and
receiving a first control switching waveform at a gate terminal that is a control terminal for the first switch while the field effect transistor operates as the switching voltage regulator; and
receiving a second control waveform at the gate terminal when the field effect transistor operates as the linear voltage regulator.

6. The method of claim 5, wherein the first control switching waveform is derived from an output of a second switch of a second switching voltage regulator.

7. The method of claim 5, further comprising:
comparing the regulated voltage of the first voltage regulator to a reference voltage with a control amplifier to provide a feedback signal to control an amount of conduction of the first switch to provide a regulated output voltage that stays within preset high and low regulated voltage level tolerances.

8. An apparatus, comprising:
a switching waveform generator to generate a switching waveform that is connected to a control terminal of a first switch of a first switching voltage regulator to control a conduction of the first switch to provide a regulated output voltage that stays within preset high and low regulated voltage level tolerances over a range of no load current to a maximum design load current, wherein the switching waveform generator includes a second switching voltage regulator having an output terminal that is connected to the control terminal of the first switch.

9. The apparatus of claim 8, wherein a first supply voltage terminal of the first switching voltage regulator and a second supply voltage terminal of the second switching voltage regulator are connected to a common supply voltage.

10. The apparatus of claim 8, wherein a regulated voltage output terminal of the second switching voltage regulator is connected to the supply voltage terminal of the first switching voltage regulator.

11. An apparatus, comprising:
a field effect transistor in a first voltage regulator that operates as both a switching voltage regulator and a linear voltage regulator based on receiving a first control signal on its control terminal when operated as a switching voltage regulator and a second control signal on its control terminal when operated as a linear voltage regulator, wherein the first voltage regulator has a first regulated voltage output terminal.

12. The apparatus of claim 11, wherein a first switch of a first voltage regulator receives the first control switching waveform from the output of a second switch of a second switching voltage regulator.

13. The apparatus of claim 11, further comprising:
a control amplifier that compares the first regulated voltage level of the first voltage regulator to a reference voltage to provide the second control signal to control an amount of conduction of the first switch to provide a regulated output voltage that stays within preset high and low regulated voltage level tolerances.

14. The apparatus of claim 13, wherein the reference voltage is derived from a second regulated voltage output terminal of the second switching voltage regulator.

15. The apparatus of claim 13, wherein the control amplifier controls the conduction of the first switch of the first voltage regulator when the first control signal is blocked via reverse biasing an input diode.

16. The apparatus of claim 12, further comprising:
a first diode and a first transistor configured to increase a current flowing to the control terminal of the first switch in the first voltage regulator to change states of the first switch in order to achieve a rise time of the second control signal to be less than five percent of a period of the second control signal.

17. A system, comprising:
a transmitter-receiver in a Discrete Multi-Tone system that has a transmitter that separates upstream communication signals and down stream communication signals into two or more distinct frequency bands and one or more voltage regulators to supply voltage to components within the transmitter-receiver, wherein a first voltage regulator has a first transistor that operates as both a switching voltage regulator and a linear voltage regulator and receives a first control switching waveform on its control terminal from an output of a second switch in a second switching voltage regulator.

18. The system of claim 17, wherein the first transistor also receives a second control signal from an operational amplifier supplying a feedback signal to control a regulated voltage output supplied by the second switching voltage regulator.

19. The system of claim 18, wherein a gate drive voltage of the first transistor is augmented through a use of a first diode and a second transistor so that the first transistor operates in a linear state of conduction to provide a regulated output voltage that stays within preset high and low regulated voltage level tolerances.

20. The system of claim 19, wherein the operational amplifier compares a regulated voltage output from the first voltage regulator to a reference voltage derived from a bandgap reference in order to generate the feedback signal.
